(19) United States
(12) Patent Application Publication
(10) Pub. No.: US 2026/0001199 A1
(43) Pub. Date: Jan. 1, 2026

(54) ROTATIONAL TOOL LOCKING DEVICE

(71) Applicant: Yi-Fu Chen, Taichung City (TW)

(72) Inventors: Yi-Fu Chen, Taichung City (TW); He-Qian Chen, Taichung City (TW)

(21) Appl. No.: 19/319,703

(22) Filed: Sep. 4, 2025

Related U.S. Application Data
(63) Continuation-in-part of application No. 17/979,774, filed on Nov. 3, 2022, now abandoned.

(51) Int. Cl. B25B 23/00

(52) U.S. Cl. CPC B25B 23/0014; B25B 23/0028

(57) ABSTRACT

A rotational tool locking device includes a handle, a drive head, a locking assembly, and an operating button. The drive head is pivotally mounted at one end of the handle, and the locking assembly is arranged between the handle and the drive head. The operating button is set on the handle and can control the locking assembly to be in a fixed or released state relative to the drive head. When in the released state, the drive head can be easily rotated relative to the handle to a specific angle, presenting different pitch positions.

### CROSS REFERENCE OF RELATED APPLICATION

This is a Continuation-In-Part patent application of the patent application Ser. No. 17/979,774, filed on Nov. 3, 2022.

### BACKGROUND OF THE INVENTION

### 1. Fields of the Invention

The present invention relates to a hand tool and more particularly to a hand tool with an angle adjusting mechanism, in which an angle between a handle and a head member pivoted on the handle is adjustable.

### 2. Descriptions of Related Art

Conventional wrenches are used for tightening or loosening workpieces, and are widely used in various places such as assembly factories, machine factories, vehicle repair shops, or home repair sites. However, conventional wrenches often cause frustration during use because when screwing or loosening workpieces, the handle can be easily blocked by obstacles, or it may be difficult to securely fit the drive head of the wrench onto the workpiece, among other limitations.

To improve the above-mentioned problems, manufacturers have developed quite a number of products for market application, such as the Taiwan Patent No. I280906 titled “Rotary Wrench Structure.” This wrench includes a body and a working head. One end of the body has a handle portion, and the other end of the body has a receiving slot forming two opposing ear portions. The receiving slot has a strip-shaped opening toward the handle portion. The periphery of the working head is connected to each ear portion by connecting pieces, allowing the working head to rotate for multi-angle operation.

However, as shown in FIGS. 1 and 2 of the aforementioned Patent No. I280906, because a strip-shaped slot is set up on the body, this slot not only requires additional machining equipment for cutting operations, but also directly weakens the lateral load-bearing strength of the body structure. Furthermore, the working head needs to be separately connected to the relatively arranged ear portions through two connecting pieces first, and then screwed onto the inner connecting sections on both sides of the working head, making assembly quite inconvenient. When adjusting the rotation angle of the working head relative to the handle, users must use other tools to first loosen and then tighten the connecting pieces in order to successfully adjust and fix the working head at the required rotation angle relative to the body.

The present invention intends to provide a rotational tool locking device to eliminate shortcomings mentioned above.

### SUMMARY OF THE INVENTION

The present invention relates to a rotational tool locking device, and comprises a handle having two ears extending from one end thereof, and a receiving slot is formed between the two ears. A lateral hole is defined in a periphery of the handle and located close to the receiving slot. A connecting hole is defined in a bottom of the receiving slot and communicates with the lateral hole. A drive head has a connecting part formed at one end thereof that fits into the receiving slot. A pivot passes through the two ears and the connecting part. Multiple teeth are formed around a periphery of the connecting part. A locking assembly is located in the connecting hole and includes a spring and an actuating member. Two ends of the spring are biased between the inner bottom of the connecting hole and the actuating member respectively. One end of the actuating member has a stopping tooth that is engaged with the teeth. The actuating member has an arc groove located corresponding to the lateral hole. The arc groove has an arc groove top surface and an arc groove bottom surface defined in an inner wall thereof. The inner wall of the arc groove is concave from a direction of the pivot toward the direction of the spring.

An operating button is slidably inserted in the lateral hole. One end of the operating button has a pushing part that pushes against the inner wall of the arc groove, and the pushing part has a pushing arc surface that abuts against the inner wall of the arc groove. When the operating button is not pressed, the pushing arc surface and the arc groove bottom surface form a first gap. When the operating button is pressed, the pushing part and the arc groove top surface form a second gap.

During normal operation, the rotational tool utilizes the spring's own elasticity to extend and push against the actuating member, causing the stopping tooth of the actuating member to continuously lock between the teeth of the drive head. When adjusting the drive head to rotate at a specific angle relative to the handle in response to environmental requirements, the user presses the operating button so that the pushing arc surface pushes against the arc groove bottom surface of the arc groove of the actuating member, causing the actuating member to displace toward the spring direction and compress the spring to store energy. Simultaneously, the stopping tooth of the actuating member disengages from its locked state with the teeth, allowing the drive head to rotate relative to the handle to the specifically required angle via the pivot shaft. The user can then release the operating button, and the spring will return from its compressed state to its normal extended state, pushing the actuating member back to its original position, so that the stopping tooth of the actuating member locks between the teeth again.

Preferably, the stopping tooth and the teeth are rectangular teeth.

Preferably, the arc curvature of the inner wall of the arc groove is greater than the arc curvature of the pushing arc surface.

The primary object of the present invention is to provide an easy-to-assemble rotational tool locking device that makes adjusting the rotation angle of the drive head relative to the handle quite convenient. Unlike conventional technology, the present invention does not require additional tools for adjustment, and it also avoids the structural strength deficiency found in conventional technology where strip-shaped slots are set in the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a partially exploded perspective view of the present invention;

FIG. 2 is a perspective view of the present invention in assembled state;

FIG. 3 is a cross-sectional view, taken along line AA of FIG. 2;

FIG. 3A is an enlarged partial view of FIG. 3;

FIG. 4 is another enlarged partial view of FIG. 3, and

FIG. 5 is a schematic view showing the operation of rotating the drive head relative to the handle of the present invention.

### DETAILED DESCRIPTION OF THE PREFERRED EMBODIMENT

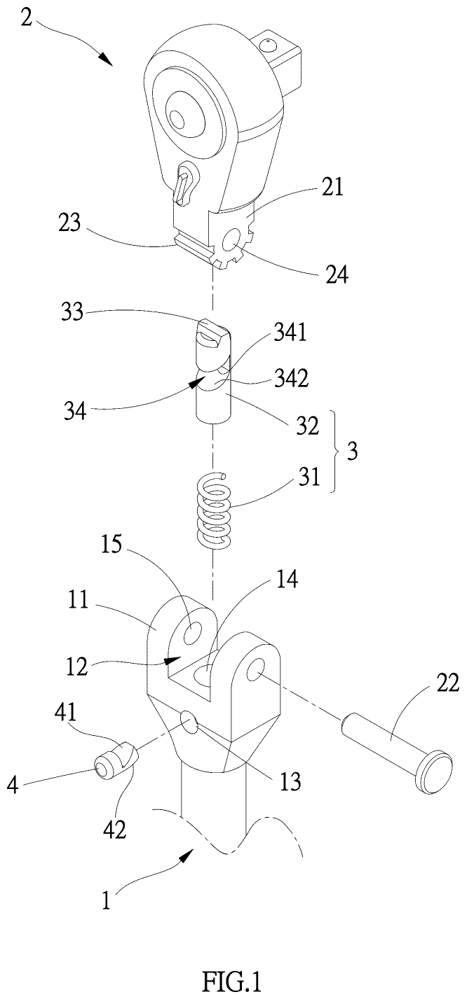

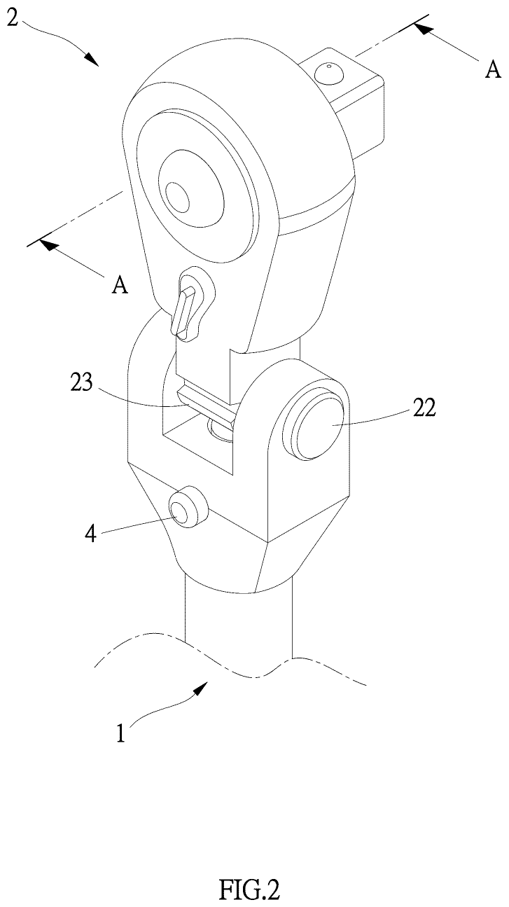

Referring to FIGS. 1 to 3, the rotational tool locking device of the present invention comprises a handle 1 having two protruding ears 11 protruding from one end thereof. A receiving slot 12 is formed between the two ears 11. The handle 1 has a lateral hole 13 defined in a periphery thereof and located close to the receiving slot 12. A connecting hole 14 is defined in a bottom of the receiving slot 12, and the connecting hole 14 communicates with the lateral hole 13. Each protruding ear 11 has a through hole 15. A drive head 2 has a connecting part 21 at one end thereof and the connecting part 21 fits into the receiving slot 12. A pivot 22 passes through the two ears 11 and the connecting part 21. Multiple teeth 23 are formed around a periphery of the connecting part 21. The drive head 2 is able to be fitted with a socket for use (not shown in the figure), and is applicable to various tools, such as ratchet wrenches, open-end wrenches, box wrenches, etc., but not limited to these. The connecting part 21 has a passage 24 located corresponding to the through hole 15. The pivot 22 passes through the through hole 15 and the passage 24 to enable the drive head 2 to rotate relative to the handle 1 via the pivot 22. A locking assembly 3 located in the connecting hole 14. The locking assembly 3 includes a spring 31 and an actuating member 32, with the two ends of the spring 31 pressing against an inner bottom of the connecting hole 14 and the actuating member 32 respectively. One end of the actuating member 32 has a stopping tooth 33 that locks between the teeth 23, and the actuating member 32 has an arc groove 34 corresponding to the lateral hole 13, the arc groove 34 having an arc groove top surface 341 and an arc groove bottom surface 342 defined in an inner wall thereof, wherein the inner wall of the arc groove 34 is concaved from the direction of the pivot 22 toward the direction of the spring 31. The actuating member 32 is generally a cylindrical component that can move axially relative to the connecting hole 14 through the extension or compression of the spring 31. An operating button 4 is slidably located in the lateral hole 13. One end of the operating button 4 has a pushing part 41 that pushes against the inner wall of the arc groove 34. The pushing part 41 has a pushing arc surface 42 that abuts against the inner wall of the arc groove 34. When the operating button 4 is not pressed, the pushing arc surface 42 and the arc groove bottom surface 342 form a first gap 51, and when the operating button 4 is pressed, the pushing part 41 and the arc groove top surface 341 form a second gap 52.

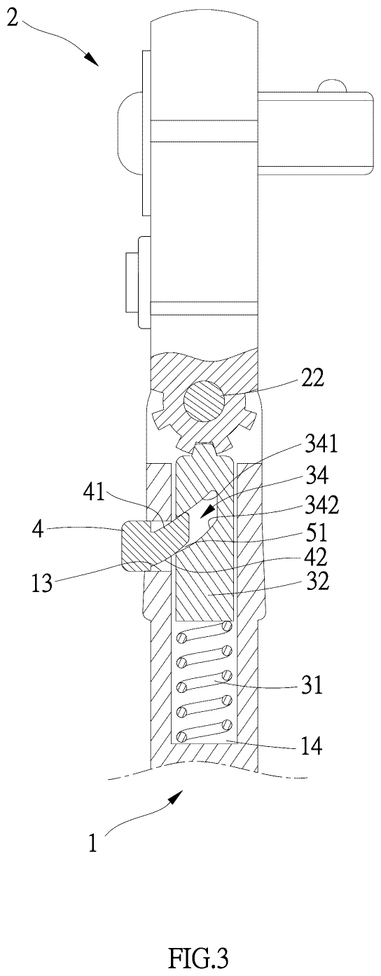

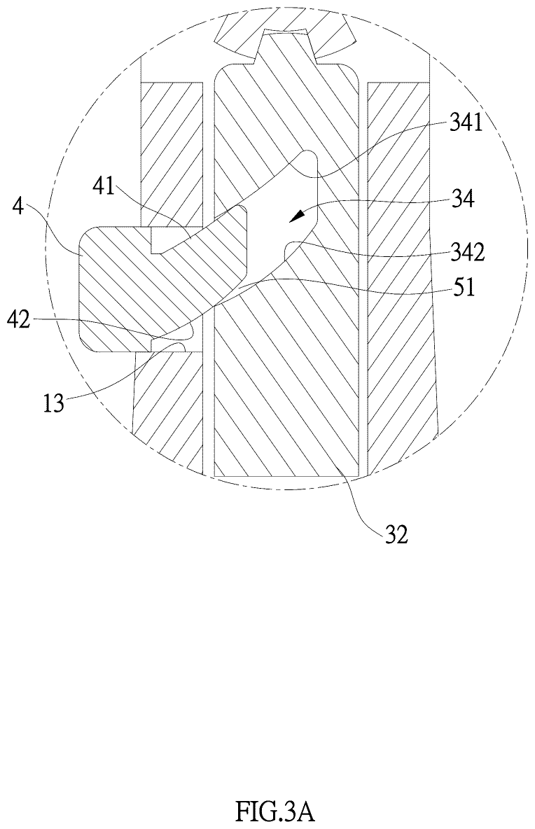

As shown in FIG. 3, the arc curvature of the inner wall of the arc groove 34 in the present invention is greater than the curvature of the pushing arc surface 42. This structure ensures that when the user presses the operating button 4, the pushing part 41 effectively pushes against the arc groove 34.

As shown in FIGS. 1 to 3, the stopping tooth 33 and the teeth 23 of the present invention are rectangular teeth (also known as square teeth or rectangular-shaped teeth in the industry). When the stopping tooth 33 of the actuating member 32 and the teeth 23 of the drive head 2 are both rectangular teeth and interlock with each other, this provides a secure engagement of the stopping tooth 33 of the actuating member 32 between two teeth 23, effectively allowing the drive head 2 to maintain a specific angle relative to the handle 1 for stable operation and use.

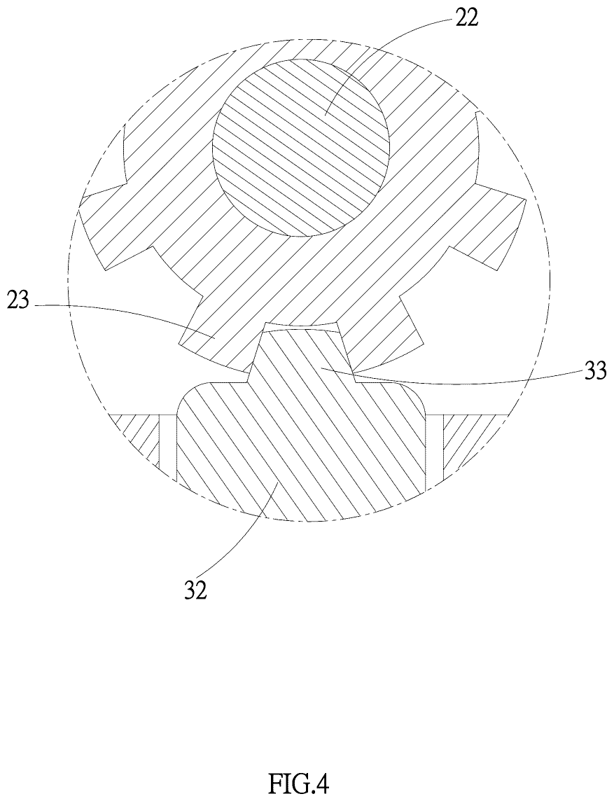

Please refer to FIGS. 3 and 4, when the rotational tool is in its normal operating state (as shown in FIG. 3), it functions through the natural extension of the spring 31, causing the two ends of the spring 31 to naturally push against the connecting hole 14 and the actuating member 32 respectively. This makes the actuating member 32 continuously push toward the direction of the drive head 2 through the spring force from the spring 31, and the stopping tooth 33 of the actuating member 32 continuously locks between any two teeth 23 of the drive head 2 (as shown in FIG. 4). This is the fixed state between the drive head 2 and the handle 1 of the rotational tool, which is ready for use or storage.

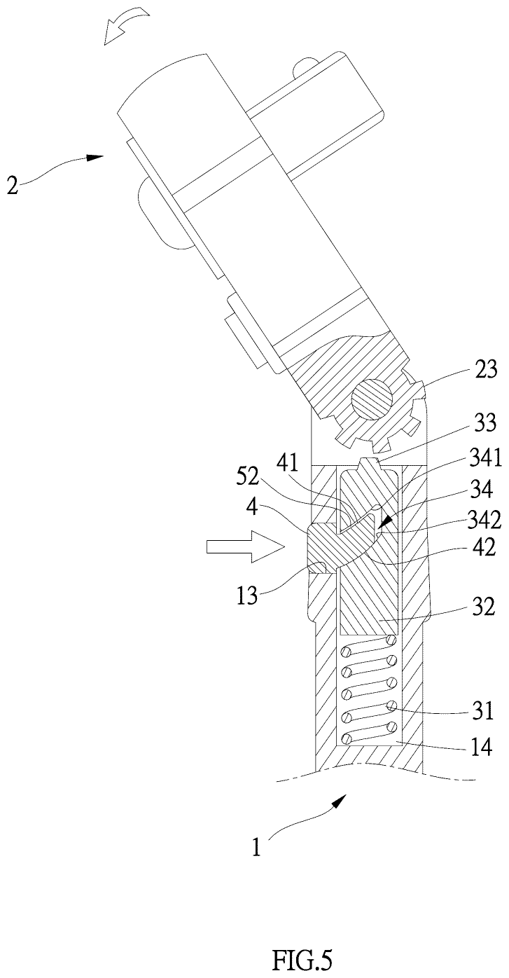

As shown in FIG. 3A and FIG. 5, whether the operating button 4 is pressed or not affects the contact condition between the pushing part 41 and the arc groove 34. When the operating button 4 is not pressed, a first gap 51 is formed between the pushing arc surface 42 and the arc groove bottom surface 342. When the operating button 4 is driven by external force, the first gap 51 between the pushing arc surface 42 and the arc groove bottom surface 342 disappears, and a second gap 52 is formed between the arc groove top surface 341 and the pushing part 41. Through this structure, the pushing part 41 is not in a state of being pressed for a long period of time, which can extend the lifespan of the components and reduce the risk of component wear or deformation. Furthermore, by establishing the first gap 51, when the operating button 4 is not pressed, the force of the spring 31 can focus on acting upon the stopping tooth 33 without interference, helping to maintain the stability of the locking function.

When the rotational tool is restricted by narrow operating environments, and the user needs to adjust the drive head 2 to rotate at a specific angle relative to the handle 1, that is, in the angle adjustment state (please refer to FIG. 5 as shown), by pressing the operating button 4, the operating button 4 moves toward the actuating member 32, with the pushing arc surface 42 of the pushing part 41 pushing against the inner wall of the arc groove 34 of the actuating member 32, causing the actuating member 32 to move toward the spring 31 direction and compress the spring 31 to store energy. Simultaneously, the stopping tooth 33 of the actuating member 32 disengages from its locked state with the teeth 23, allowing the drive head 2 to rotate relative to the handle 1 at a specific required angle around the pivot 22 as the axis, presenting different pitch positions. At this point, the operating button 4 can be released, and the spring 31 can naturally extend from its compressed state to push the actuating member 32 back to its position, again presenting the stopping tooth 33 of the actuating member 32 locking between any two of the teeth 23.

From the above description of the operation and functions of the present invention, the present invention is indeed an easy-to-assemble rotational tool locking device. Moreover, when adjusting the drive head 2 to rotate relative to the handle 1 to present different pitch angles, one only needs to directly press the operating button 4 to release the fixed state of the drive head 2 relative to the handle 1. Therefore, the present invention makes it quite convenient to operate and adjust the rotation of the drive head 2 relative to the handle 1, without requiring adjustment through additional tools like conventional tools, and it also does not have the deficiency of insufficient structural strength caused by strip-shaped slots set on the handle as in conventional tools.

While we have shown and described the embodiment in accordance with the present invention, it should be clear to those skilled in the art that further embodiments may be made without departing from the scope of the present invention.

What is claimed is:

1. A rotational tool locking device, comprising:
a handle having two ears extending from one end thereof, a receiving slot formed between the two ears, a lateral hole defined in a periphery of the handle and located close to the receiving slot, a connecting hole defined in a bottom of the receiving slot and communicating with the lateral hole;
a drive head having a connecting part formed at one end thereof that fits into the receiving slot, a pivot passing through the two ears and the connecting part, multiple teeth formed around a periphery of the connecting part;
a locking assembly located in the connecting hole and including a spring and an actuating member, two ends of the spring biased between an inner bottom of the connecting hole and the actuating member respectively, one end of the actuating member having a stopping tooth that is engaged with the teeth, the actuating member having an arc groove located corresponding to the lateral hole, the arc groove having an arc groove top surface and an arc groove bottom surface defined in an inner wall thereof, the inner wall of the arc groove being concave from a direction of the pivot toward the direction of the spring, and
an operating button slidably inserted in the lateral hole, one end of the operating button having a pushing part that pushes against the inner wall of the arc groove, the pushing part having a pushing arc surface that abuts against the inner wall of the arc groove, when the operating button is not pressed, the pushing arc surface and the arc groove bottom surface form a first gap, and when the operating button is pressed, the pushing part and the arc groove top surface form a second gap.

2. The rotational tool locking device as claimed in claim 1, wherein the stopping tooth and the teeth are rectangular teeth.

3. The rotational tool locking device as claimed in claim 1, wherein an arc curvature of the inner wall of the arc groove is greater than an arc curvature of the pushing arc surface.
